(19) United States
(12) Patent Application Publication
(10) Pub. No.: US 2018/0236352 A1
(43) Pub. Date: Aug. 23, 2018

(54) WEARABLE INERTIAL ELECTRONIC DEVICE

(71) Applicant: UTI Limited Partnership, Calgary (CA)

(72) Inventors: Naser El-Sheimy, Calgary (CA); Qifan Zhou, Calgary (CA); Hai Zhang, Beijing (CN)

(73) Assignee: UTI Limited Partnership, Calgary, AB (CA)

(21) Appl. No.: 15/755,538

(22) PCT Filed: Aug. 26, 2016
(86) PCT No.: PCT/IB2016/055091

§ 371 Date: Feb. 26, 2018

Related U.S. Application Data
(60) Provisional application No. 62/262,987, filed on Dec. 4, 2015.

(51) Int. Cl. A63F 13/211; A63F 13/212; A63F 13/24; A63F 13/816; A63F 13/428; A63F 13/235; G01C 19/5776; G06F 3/01; G06F 3/0346

(52) U.S. Cl. CPC A63F 13/211; A63F 13/212; A63F 13/24; A63F 13/816; G06F 3/0346; A63F 13/235; G01C 19/5776; G06F 3/011; G06F 3/017; A63F 13/428

(57) ABSTRACT

Embodiments of wearable electronic devices in game play applications are described. In an embodiment a method may include receiving a signal characteristic of movement of a MEMS inertial sensor (202) configured to generate data in response to movement of a human foot. The method may also include processing the signal received from the MEMS inertial sensor (202), in a processing device (203), to generate a command input for an application processing device (206, 208, 210, 212). Additionally, the method may include communicating the command input to the application processing device (206, 208, 210, 212) for control of an application hosted on the application processing device.

### FIELD

This disclosure relates generally to wearable electronics, and more specifically, to wearable electronic devices in game play applications.

### BACKGROUND

In recent years, with the rapid development of MicroElectroMechancial System (MEMS) technology, inertial sensor production has made a leap forward in terms of chip-size minimization, low-cost manufacturing, lower power consumption and simplification in operation. Due to these advantages, various types of inertial MEMS sensors have become appropriate for multiple applications, such as vehicle or person navigation, motion tracking system, consumer electronic devices, such as smartphones. The emergence of wearable electronic devices during the last few years also make use of the low-cost MEMS inertial sensor, and are becoming more and more popular in the consumer market.

The term “wearable electronic devices” refer to electronic technologies or devices that are incorporated into items of clothing and accessories which can comfortably be worn on the body. Generally, these devices can perform communications and allow the wearer access to their activity and behavior information. The implications and uses of wearable technology are far reaching, and can influence the fields of health and medicine, fitness, aging, disabilities, education, transportation, enterprise, finance, and sports. Currently, numerous types of wearable electronic devices have been developed and employed in various applications.

In the medical field, the wearable electronic devices are designed to provide opportunities for improving personalized healthcare. They can be applied to monitor the critical physiological parameters of patients and caregivers, such as body temperature, heart rate, brain activity, muscle motion and other data. With the development of smart mobile device, the collected human health care data can be transmitted to their family member or doctor for reference. The use of wearable sensors has made it possible to have the necessary treatment at home for patients after an attack of diseases such as heart-attacks, sleep apnea, Parkinson disease and so on.

In the sports and fitness field, the daily activities and sports performed by the subjects can be recognized. The energy expenditure during the sports movement can also be estimated to access the activity level of a subject. Additionally, the sweat rate, gait analysis during walking, kinematic changes evoked by fatigue in running, etc. can all be accomplished with wearable electronic devices. The FitBit™, the Nike+™ and FuelBand™ are representative of wearable electronic products in the sports market. These devices are very popular in younger market segments, and have experienced a period of rapid growth during last few years.

Except for the medical and sports field, the application of wearable device has also made it possible to aid patients' rehabilitation at home. Such networks can ensure that patient motion can be monitored by doctor or family members. The wearable obstacle detection/avoidance systems (ETAs) has been developed to assist visually impaired people during navigation in known or unknown, indoor or outdoor environments. There are even wearable devices specially designed for wild animals, aiming to record their normal life and activity range.

Wearable electronic devices have made a great improvement and attracted attention in various industries. Prior devices have digitalized human motions or activities to provide users with vital information. However, the functionality of most wearable devices has been limited. For example, many devices are limited in functionality to the mere role of a step counter, vital signs information monitor, motion data recorder, calorie calculator right, or the like. Devices have not developed with multi-function capability for entertainment, game play, and Human Computer Interaction (HCl) fields.

On the other side, these systems have the problem that they can only provide user's general motion information, such as discrimination of movement activity from rest, classification of activities (i.e. running, walking, sleeping), and the quantization of general movement intensity (i.e. percentage of time spent moving, sleeping, sitting). These systems are just playing a role of human motion data recorder or monitor, and their performance does not have a direct effect on the utilization because the user cannot experience whether the motion identification is accurate or not. Additionally, several work adopt a heavy burden feature extraction procedure and post processing techniques, so it is impossible to derive a real time human motion result. The test or validation of real time application has not been discussed in previous work.

In human body motion capture field, multiple inertial sensor nodes are attached to different body parts, and the detailed movement information of human body, including human head, upper limb, lower limb, foots can be derived accurately in real time. Several attractive research works have been proposed in this area and most of them focused on the determination of attitude to correct the accumulated error caused by sensor drift. Nevertheless, this kind of system needs at least seventeen inertial nodes attached to body parts, and requires a setup up and calibration session before usage, which brings a heavy burden and is not comfortable or convenient for people to wear and serve for our regular utilization. Therefore, this system is only employed in some specific applications (i.e. movie making, cartoon producing), and rarely applied in our daily life.

### SUMMARY

Embodiments of wearable electronic devices are presented for applications. In an embodiment, the wearable electronic device may be attached to a user's foot. In such an embodiment, the wearable electronic devices may detect the user's steps in different directions to control the player's move presented in an application, such as a game.

In an embodiment a method may include receiving a signal characteristic of movement of a MEMS inertial sensor configured to generate data in response to movement of a human foot. The method may also include processing the signal received from the MEMS inertial sensor, in a processing device, to generate a command input for an application processing device. Additionally, the method may include communicating the command input to the application processing device for control of an application hosted on the application processing device.

Embodiments of an apparatus may include a MEMS inertial sensor configured to generate a signal characteristic of movement of the MEMS inertial sensor, a processing device configured to process signals received from the MEMS inertial sensor to generate command inputs for the application processing device, and an output interface, coupled to the processing device and in communication with the input interface of the application processing device, the output interface configured to communicate the command inputs to the application processing device for control of the application.

Embodiments of a system may include an application processing device configured to execute operational commands of an application, the application processing device comprising an input interface. The system may also include a wearable motion detection device coupled to the application processing device via the input interface. The wearable motion detection device may include a MEMS inertial sensor configured to generate a signal characteristic of movement of the MEMS inertial sensor, a processing device configured to process signals received from the MEMS inertial sensor to generate command inputs for the application processing device, and an output interface, coupled to the processing device and in communication with the input interface of the application processing device, the output interface configured to communicate the command inputs to the application processing device for control of the application.

Further embodiments of a hardware platform for a wearable electronic device are described, which include a low cost microcontroller and a 9-axis MEMS inertial sensor. The described embodiments may be linked with software applications, such as gaming applications for an interactive experience in playing action games and widen the wearable electronic devices' function.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a conceptual diagram illustrating one embodiment of a system for wearable electronic devices in game play applications.

FIG. 2 is a functional block diagram of a system for wearable electronic devices in game play applications.

FIG. 3 is a schematic block diagram illustrating a system hardware platform for wearable electronic devices in game play applications.

FIG. 4 is a schematic block diagram illustrating an embodiment of a method for wearable electronic devices in game play applications.

FIG. 5 is a diagram illustrating a process for inertial sensor measurement alignment.

FIG. 6 is a diagram illustrating an embodiment of stepping acceleration signals and gait phases.

FIG. 7A is a diagram illustrating an embodiment of an acceleration signal segment corresponding to a forward step.

FIG. 7B is a diagram illustrating an embodiment of an acceleration signal segment corresponding to a backward step.

FIG. 7C is a diagram illustrating an embodiment of an acceleration signal segment corresponding to a left step.

FIG. 7D is a diagram illustrating an embodiment of an acceleration signal segment corresponding to a right step.

FIG. 7E is a diagram illustrating an embodiment of an acceleration signal segment corresponding to a jump.

FIG. 8 is a diagram illustrating one embodiment of a decision tree classification model.

FIG. 9 is a diagram illustrating one embodiment of a k-nearest neighbor algorithm classification model.

FIG. 10 is a diagram illustrating one embodiment of a support vector machine classification model.

FIG. 11A illustrates one embodiment of a hardware platform.

FIG. 11B illustrates one example of sensor placement on a shoe.

FIG. 11C illustrates one example of sensor placement on a shoe.

FIG. 11D illustrates one example of sensor placement on a shoe.

FIG. 11E illustrates one example of sensor placement on a shoe.

FIG. 12 is a graphical representation of an accuracy comparison of three classification models.

FIG. 13 is a graphical representation of a precision comparison of three classification models.

FIG. 14A illustrates a first game play test scenario.

FIG. 14B illustrates a second game play test scenario.

### DETAILED DESCRIPTION

The present embodiments include foot-mounted wearable electronic devices for use in game play and for user interface for other applications. In an embodiment, the system may identify human foot stepping directions in real time, and coordinate these foot actions to control the player presented in game or application control. In an embodiment, one IMU configuration is selected to make it convenient and suitable for user to wear. In an embodiment, a method may include preprocessing collected dynamic data to compensate error and correct the sensor misalignment, detecting the peak points of acceleration norm for data segmentation and to extract the feature in the vicinity of each peak point, and putting the features into the machine learning classifier to determine the stepping motion type. In a further embodiment, the corresponding classifier may be trained for individual motion type to improve the robustness of the system.

The present embodiments may employ a foot-mounted wearable electronic device to play a game. Additionally, the present embodiments may compute efficient, real time applicability foot moving direction identification algorithm. Such embodiments do not require specific sensor orientation on the shoe, that it can be generally applied for different shoe styles and placement manners. The embodiments may provide a low-cost, small size, portable, wireless inertial measurement unit and a game play software platform to synchronize the foot motion with the game or other application operation.

The present embodiments provide several benefits and advantages. First, such embodiments extend the current electronic wearable devices to game play beyond human activity recognition and monitoring. Also, with the present embodiments, kinetic games need not to be limited to a confined space (i.e. living room) or played on any specific processing consul or system, but instead may be playable with various convention processing devices, such as smartphones or tablets. Such embodiments also enable building of low-cost, portable, wearable, real time exercising and entertainment platform, that people are able to perform virtual sports or exercise in an interesting manner without environmental constrains, which is convenient to use and beneficial for their health.

One of the most commonly used and traditional game operating mode is that user controls the subject's directions (forward, backward, left or right), aiming to avoid obstacles, or to achieve more bonuses in several popular smartphone running games. Based on this user's operation mode, a benefit of a foot-mounted system is to utilize people step moving directions to control the player avatar or object presented in a game or application, instead of the conventional manner (i.e. finger sliding, button press). Specifically, the inertial sensor may be attached on the human foot, process the sensor data collected during the moving phase to derive the stepping directions, and correlate the human step direction to the subject control in games.

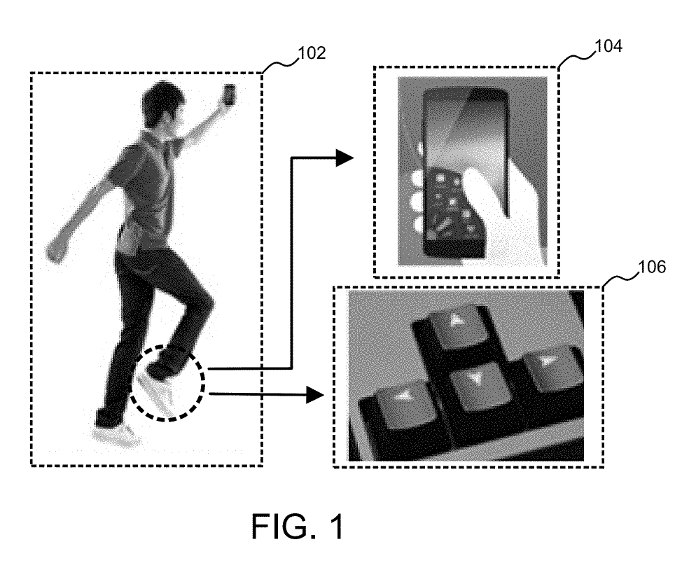

FIG. 1 illustrates a process using foot kinetic motions detected by inertial sensor to replace the traditional game controller or operation manner. A user's stepping forward or jumping and stepping backward motions shown at block 102 may correlate to the press of up and down buttons as shown in block 106, or finger slides up and down as shown in block 104, and similarly, a user's walking left and right correlate to the press of left or right buttons as shown at block 106, or finger slides right and left as shown at block 104.

This system has a high real time and detection accuracy requirement because any lag or wrong step detection result will cause the user discontinue playing game normally, and lead to a worse user experience. Hence, a challenge resolved by the present system is to determine step motion and moving directions correctly when the step event happens with less delay, and synchronize to game control to give the user feedback. Moreover, due to the diversity of shoe styles and sensor mounted manners, the compatibility of algorithms with different users, and the system robustness are other difficult challenges to overcome by the present embodiments.

System Architecture

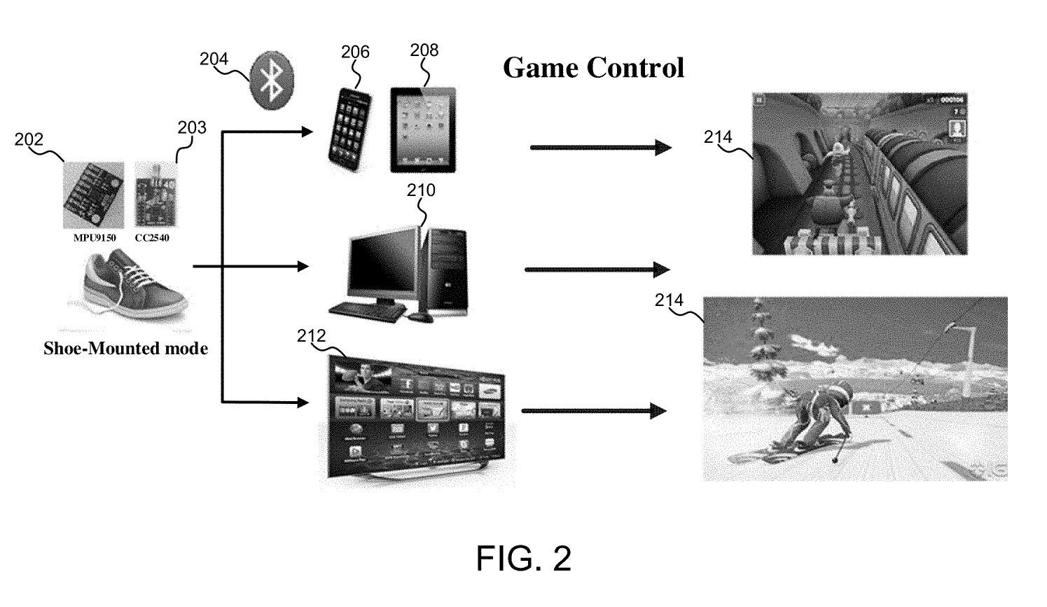

FIG. 2 illustrates an embodiment of a system architecture, wherein kinetic foot motion dynamic data captured by an inertial sensor 202 may be wirelessly transmitted to various kinds of processing terminals, such as smartphones 206, tablets 208, computers 210, and smart televisions 212 through, for example, a Bluetooth 4.0 link 204. In an embodiment, a processing application or software module, which is compatible in different platforms, may receive step sensor data, perform detection algorithms, and interact with games or applications. Both hardware and software platforms are included in such a system, and they are separately described herein.

Hardware Platform

The system hardware platform may include a processing device 203, such as a CC2540 microprocessor, an inertial sensor 202, such as a 9-axis inertial sensor MPU9150, and other electronic components, such as communication components, power supply circuits, etc. The processor 203, may include a 2.4 GHz Bluetooth low energy System on Chip (SOC) and a high performance and low-power 8051 microcontroller. Such an embodiment can run both application and BLE protocol stack, so it may be compatible with multiple mobile devices (i.e., smartphones 206, tablets 208, etc.). The inertial sensor may include an integrated 9-axis MEMS motion tracking device that combines a 3-axis gyroscope, a 3-axis accelerometer, and a 3-axis magnetometer, for example.

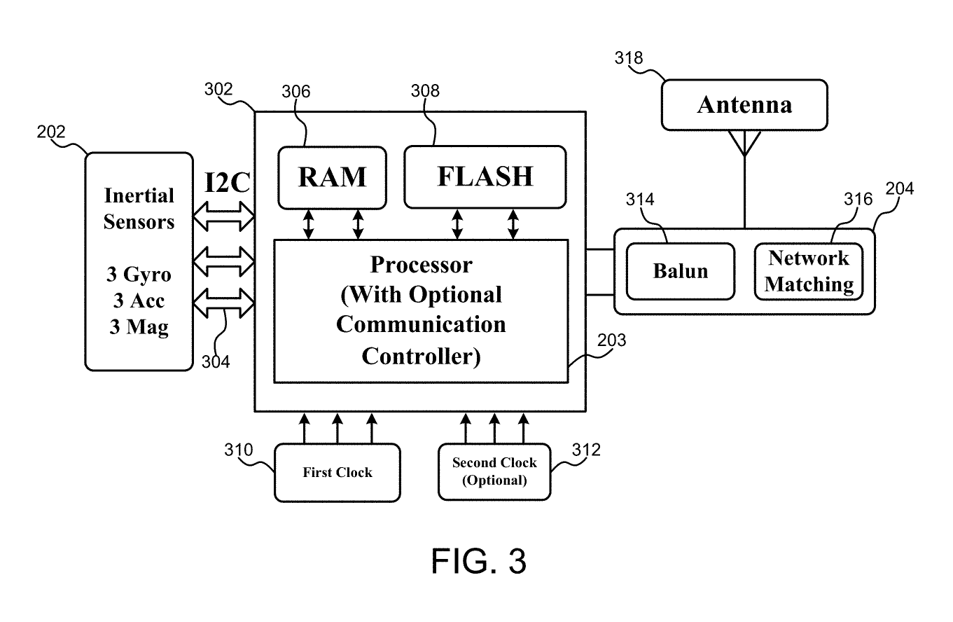

FIG. 3 shows an embodiment of a system hardware platform. In such an embodiment, the processing core 302 may receive inertial sensor data from the inertial sensors 202 through a data connection or data bus 304, such as an II2 (I2C) interface. The data may be received in a pre-set sampling frequency as defined by the first clock 310. The processor 203 may package data in a pre-defined user protocol, and send data via a wireless communication interface 204 to a host, such as a smartphone 206 or tablet 208. The wireless communication interface 204 may include a balun 314 and network matching 316 component for handling received data and matching impedances of Radio Frequency (RF) components, such as the antenna 318. The processing core 302 may further include memory devices, such as Random Access Memory (RAM) 306 and flash memory 308 for storing sensor data received from the inertial sensors 202.

Software Platform

The system software platform may be developed in any suitable programming language or syntax, such as C, C++, C#, Python, etc. In an embodiment, the software modules, when executed by the processing device 203, may be configured to receive and decode data from the internal sensors 202, log user's motion data, calculate the attitude of the motion, run the human foot detection algorithm, and interact the human motion with game or application control on the host. For real-time processing, a multi-threaded program may simultaneously implement these functions. Multithreading is a widespread programming and execution model that allows multiple threads to exist within the context of a single process. These threads share the process's resources, but are able to execute independently. Hence, this multithreading software can guarantee the whole system's real-time application, and owns a clear structure which is beneficial for further revision or development.

Methodology

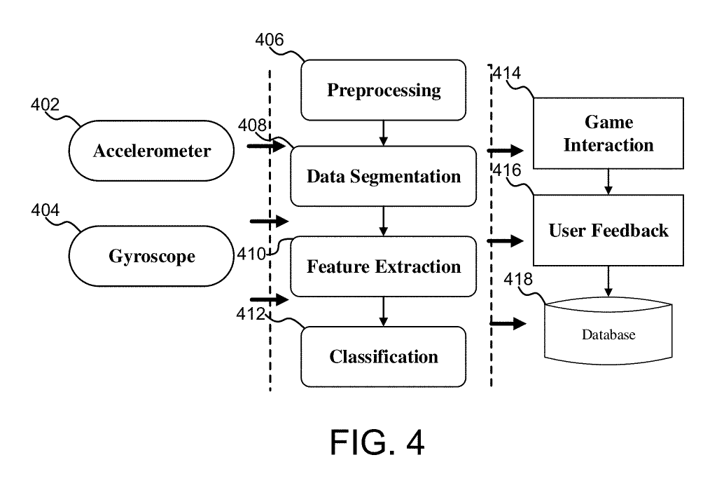

The inertial sensor 202 may be attached on a foot or shoe, and the measured rotation information and acceleration information received from the accelerometer 402 and the gyroscope 404 may be applied for stepping direction classification. The motion recognition process of the present embodiments is illustrated in FIG. 4.

As shown in FIG. 4, the process may include pre-processing raw inertial data, as shown at block 406, for error compensation, noise reduction and misalignment elimination. At block 408, the method may include detecting the peak points of the norm of 3-axis acceleration to segment data. Additionally, the selected features in the divided data segment may be extracted and put into the classifier to derive the foot motion types, as shown at blocks 410 and 412.

Preprocessing

MEMS inertial sensor has the advantageous of small size and affordability, but they suffer from various error sources that cause a negative effect on their performance. Therefore, the calibration experiments are dispensable operation before usage of MEMS sensor to remove the deterministic errors, such as bias, scale factor error, misalignment. Currently, because of the advanced MEMS manufacturing technology, the inertial sensor is highly integrated and non-orthogonally errors are relatively smaller compared with other errors. Hence, only bias and scale factor errors are considered here, and the error compensation model is described as follows:

\tilde{f}^{b}=S_{b}·f^{b}+bₐ

\tilde{ω}^{b}=S_{ω}·ω^{b}+b_{ω} (1)

Where, \tilde{f}^{b}, \tilde{ω}^{b} denote the measurement of specific force and rotation, and f^{b}, ω^{b} denote the true specific force and angular velocity. S_{b}, S_{ω}, bₐ, b_{ω} respectively denote the scale factors and biases of accelerometer and gyroscope, and they are all derived from the calibration experiment.

In the present embodiments, the IMU may be attached to a shoe to detect the user's foot motion to control the game. However, due to the difference between various shoe styles and the sensor placement, the IMU orientation (pitch and roll) varies when mounting on different user's shoes, which causes the misalignment with different users.

Hence, in order to achieve a satisfactory identification results for different shoe styles or placement manners, the data may be collected under various attachment conditions and put into a training process to derive the classifier, but this process is time consuming and the performance is not guaranteed if the sensor is attached with a new misalignment condition which is not included in the training set. Therefore, the present embodiments may project the acceleration and rotation measurement from body-frame (shoe frame) to user frame, and use the information in user frame for motion classification, where the user frame separately denotes the user's right, left and up directions as three axes to construct the coordinate. This operation is able to effectively eliminate the misalignment caused by different shoes styles and sensor placement because it aligns all the collected data in the same frame.

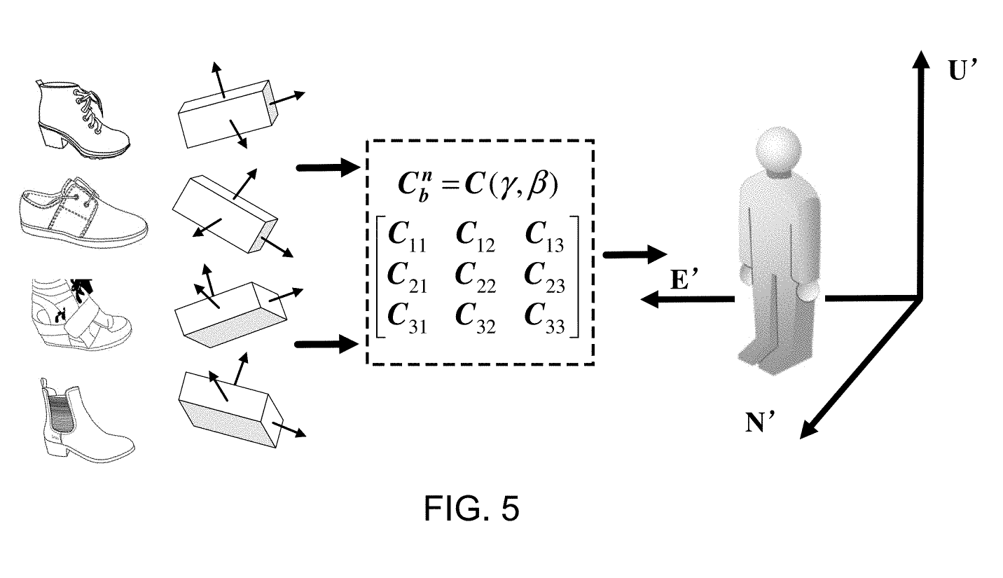

FIG. 5 shows the alignment process with the rotation matrix C_{b}ⁿ, that the inertial data collected under different misalignment conditions are scaled in the same frame (Right-Forward-Up). The data expressed in this frame can directly reflect the actual user moving direction in horizontal plane, which provides a better data basis for the consequent signal process, and is beneficial to achieve a more robust result.

Hence, a reliable and accurate attitude result is beneficial because it can correctly project the inertial measurement in user frame with the rotation matrix to perform the data standardization process (align in the same frame), and consequently derive a dependable feature extraction. With the given initial attitude and the gyroscope measurement, the orientation results by integrating the angular velocity can be derived. However, due to the error of MEMS gyroscope, the attitude result drifts quickly with time and is not able to provide long term solution. The accelerometer can provide attitude angles without suffering from long term drift which is complementary with gyroscope data, and is effective to compensate the attitude drift error. The present embodiments may use an attitude filter to integrate the gyroscope and accelerometer measurement data together to derive the non-drift attitude solution. A Kalman filter may be used to fuse the information, the dynamic model, measurement model of the filter, and an adaptive measurement noise tuning strategy are described as follows.

Dynamic Model

The attitude angle error model, which is the angle difference between true navigation frame and the computed navigation frame, is employed as the dynamic model. This model is expressed in linear form, and easy to implement. The 3-axis gyro biases are also included in the dynamic model, they are estimated in the filter and work in the feedback loop to mitigate the error from raw measurement. The equation of dynamic model may be expressed as:

\dot{Φ}=Φ×ωᵢₙⁿ+C_{b}ⁿε^{b}

\dot{ε}^{b}=(−1/τ_{b})\dot{ε}^{b}+ω_{b} (2)

Where, Φ denotes the attitude error, ωᵢₙⁿ denotes the n frame rotation angular rate vector relative to the inertial frame (i frame) expressed in the n frame. C_{b}ⁿ denotes the Direction Cosine Matrix (DCM) from b-frame (i.e., the body frame) to n-frame (i.e., the navigation frame). The symbol “x” denotes cross product of two vectors. ε^{b} denotes the gyros output error. Such embodiments only require consideration of the effect of gyro bias and it is modeled as first order Gauss-Markov process, τ_{b} denotes the correlation time of the gyro biases and ω_{b} is the driving noise vector.

Measurement Model

The acceleration residuals in the body frame may be used to derive the system measurement model. In an embodiment, the acceleration difference may be used instead of using attitude difference separately derived by accelerometer and gyroscope is to avoid the singularity problem when the pitch angle is ±90°. The acceleration residuals in body frame are defined as the difference of accelerometer direct measurement and the project of local gravity.

δa=aₘ^{b}−aₙ_{_{c}}^{b}

aₙ_{_{c}}^{b}=Cₙ_{_{c}}^{b}aⁿ (3)

Where, aₘ^{b} denotes the accelerometer measurement, aₙ_{_{c}}^{b} denotes the local gravity project in body frame using the gyros derived rotation matrix Cₙ_{_{c}}^{b}. n_{c} denotes the computed navigation frame. According to the DCM chain rule, Cₙ^{b} is expressed as:

Cₙ^{b}=Cₘ_{_{c}}^{b}Cₙⁿ^{_{c}}

Cₙⁿ^{_{c}}=I−[Φx] (4)

Where, [Φx] denotes the skew matrix of attitude error. Substituting equation (4) into equation (3), the relationship between acceleration residuals in body frame and attitude error is written as:

$$\begin{matrix}δ a = {a}_{m}^{b} - {a}_{{n}_{c}}^{b} \\ = {C}_{n}^{b} {a}^{n} - {C}_{{n}_{c}}^{b} {a}^{n} \\ = ( {C}_{n}^{b} - {C}_{{n}_{c}}^{b} ) {a}^{n} \\ = ( {C}_{{n}_{c}}^{b} {C}_{n}^{{n}_{c}} - {C}_{{n}_{c}}^{b} ) {a}^{n} \\ = {C}_{{n}_{c}}^{b} ( I - [ ψ \times ] - I ) {a}^{n} \\ = {C}_{{n}_{c}}^{b} ( - [ ψ \times ] ) {a}^{n} \\ = {C}_{{n}_{c}}^{b} ( [ {a}^{n} \times ] ) ψ\end{matrix} \qquad ( 5 )$$

Then, the measurement model can be obtained by equation (5), the measurement z is the acceleration in body frame [δaₓ δa_{y} δa_{z}]^{T}, and the measurement matrix H is expressed as

$$H = [ \begin{matrix}- {gC}_{{n}_{c}}^{b} ( 1 , 2 ) & - {gC}_{{n}_{c}}^{b} ( 1 , 1 ) & 0 & 0 & 0 & 0 \\ - {gC}_{{n}_{c}}^{b} ( 2 , 2 ) & - {gC}_{{n}_{c}}^{b} ( 2 , 1 ) & 0 & 0 & 0 & 0 \\ - {gC}_{{n}_{c}}^{b} ( 3 , 2 ) & - {gC}_{{n}_{c}}^{b} ( 3 , 1 ) & 0 & 0 & 0 & 0\end{matrix} ] \qquad ( 6 )$$

The attitude filter works effectively under stationary or low acceleration conditions, because the attitude estimated by accelerometer measurements perform well and is positive in fixing the accumulated attitude error. While in high dynamic situation, the accelerometer will sense the external dynamic acceleration, so if the contribution of measurement update still keeps same with that in low dynamic situation, a side effect will be introduced and lead to a degraded performance. Hence, to achieve an optimal attitude estimation result, the present embodiments may adaptively tune the measurement covariance matrix R according to a system dynamic index E and it is designed as:

ε=|f−g| (7)

Where, f denotes the norm of measured acceleration, g denotes the local gravity. Then the specific tuning strategy of covariance matrix R may include a stationary mode, a low acceleration mode, or and a high dynamic mode. In stationary mode, when ε<Thres1, it denotes that the system is in stationary or low acceleration status, correspondingly, the covariance matrix R is set as R=diag[σₓ² σ_{y}² σ_{z}²], σₓ², σ_{y}², σ_{z}² denote the velocity random walk of three-axis accelerometer. In low acceleration mode, when Thres1<ε<Thres2, it means that the system suffers from low external acceleration and the covariance matrix R is set as R=diag[σₓ² σ_{y}² σ_{z}²]+kε², where k is the scale. In high dynamic mode, when ε>Thres2, norm of the three accelerations is far from the specific force which equals to gravity acceleration. The acceleration residuals are not reliable. In this situation, the filter only performs the prediction loop, and has no measurement update.

Data Segmentation

Data segmentation may divide the continuous stream of collected sensor data into multiple subsequences, and a selected subset of information for the activity recognition. In an embodiment a sliding windows algorithms may be used to segment data in various applications. However, this approach is not suitable in all embodiments because the entire human stepping motion signal may not be included in the current detected window, and is separated in two adjacent windows, which may cause poor results in some cases. Moreover, the sliding windows algorithm works with a complexity of O(nL), where L is the average length of a segment, and affect the system real time ability.

In further embodiments, the relationship between gait cycle and acceleration signal may be analyzed to derive a practical approach to segment data. Generally, a gait cycle can be divided into four phases, namely: (1) Push-off—heel off the ground and toe on the ground; (2) Swing—both heel and toe off the ground; (3) Heel Strike—heel on the ground and toe off the ground; and (4) Foot stance phase—heel and toe on the ground at rest.

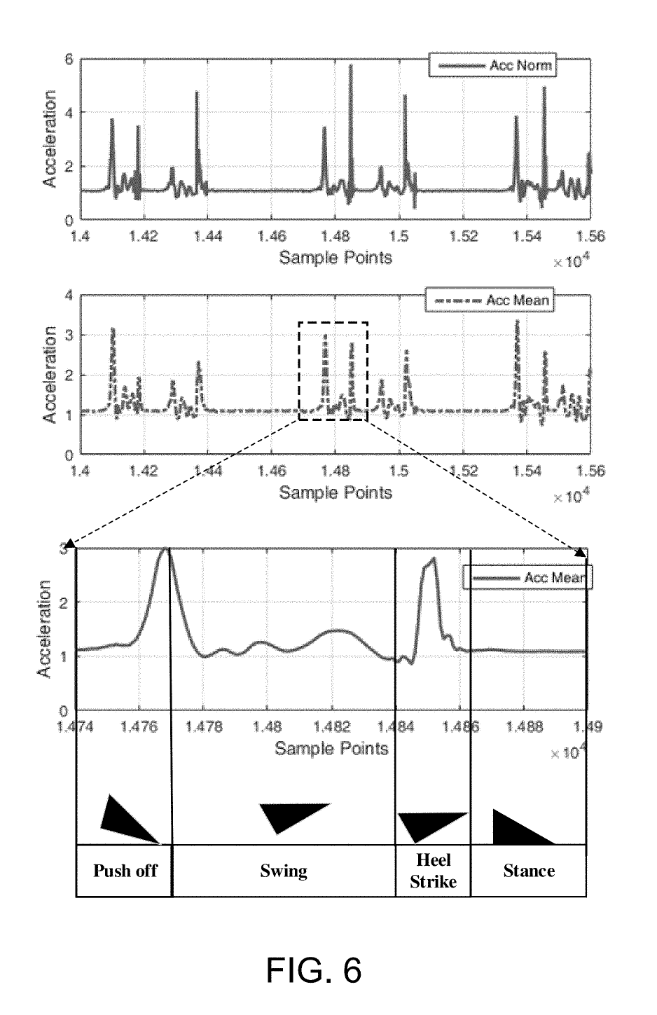

FIG. 6, illustrates the average of acceleration and smoothed acceleration signals by a moving average algorithm, where for each epoch, a window containing the previous N sample points is averaged to produce the acceleration value, and the reason is to derive a smoother form of signal, deduce noise, and eliminate unexpected peak points.

FIG. 6 illustrates that the smoothed acceleration signal during one walking circle generally features two peak points, one is in the push-off phase that the foot is leaving the ground and another one is in the heel-strike phase that the foot hits the ground. Although it may not hold for each walking circle, that more than two peak points are available in one cycle, due to different user habits of motion strength, these two points are always available in each gait cycle. The present embodiments may utilize the peak point to trigger the date segmentation process, that once one peak point is detected, the feature in the vicinity of this point may be extracted and consequently decide the foot motion type.

The reason for using peak point is that one peak point is always available in the push-off phase when the foot leaves ground and it facilitates to detect the beginning of a user step, which will not vary for different users or stepping patterns, and ensures the reliable real time performance. On the other side, the algorithm complexity works with the O(peak point number) that the classification process is only performed when the peak point is detected, which decreases the computation burden. Moreover, the present embodiments do not require classification of the specific phase of each walking circle, and it simplifies the identification process

Additionally, the present embodiments may ascertain the length of data for feature extraction. A tradeoff is available here between discrimination accuracy of motion types and real time applicability. Involving more data in data segmentation is beneficial to correctly identify human motion, lead to good result, but will cause a lag response. While, less data can achieve a quick and less delay judgment on human motion, but may does not include enough information for the classification. The present embodiments include analyzing the distribution of three separate axis acceleration signal of different motions, to figure out the length of data segment for feature extraction.

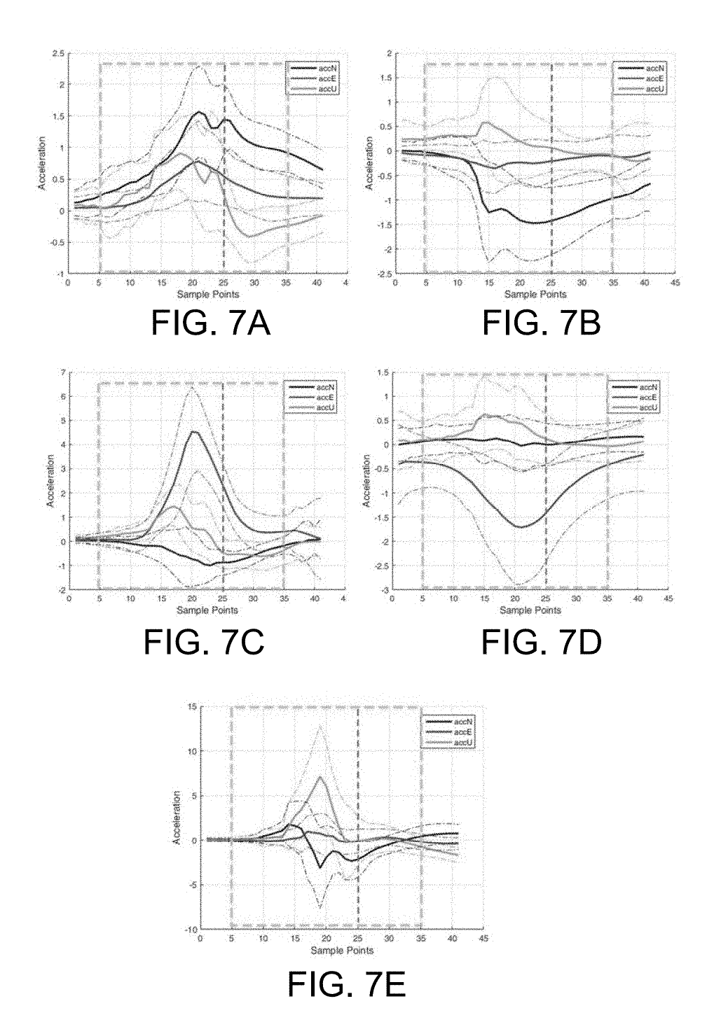

FIGS. 7A-7E illustrate the collected three axes acceleration signals in the vicinity of the peak point in the beginning stage of a step. FIG. 7A represents an acceleration signal collected from forward motions. FIG. 7B represents an acceleration signal collected from backward motions. FIG. 7C represents an acceleration signal collected from left motions. FIG. 7D represents an acceleration signal collected from right motions. FIG. 7E represents an acceleration signal collected from jump motions. The solid lines denote the acceleration signal presented in user frame. The dot line which drawn from top to bottom denotes the position of the peak point, which suffers a shift in right side with the acceleration peak points for the reason of the mean average algorithm, but it will not cause any negative effect. The present embodiments may use the acceleration signals to invest the data segment length because they experience different performance during the process of human stepping in various directions, and they are able to provide us an intuitive, direct, and easy understanding manner to recognize the moving directions. For example, FIG. 7C illustrates the left motion, and the acceleration in user's right direction features an obvious difference compared with the other two axes, similarly, for the forward and backward motions, the acceleration in forward or backward direction patterns more diversity.

Additionally, each figure illustrates the acceleration distribution of 500 same motions performed by different testers, and extract data in the vicinity of first peak point, and calculate the mean and standard deviation of these data. The solid lines and dot lines separately present the mean and standard deviation. The acceleration distribution shown in the figure provides an intuitive statistical result of acceleration in the beginning phase of a step and is helpful for us to confirm the data segment length. The data segmentation length was select to extract features is 31 samples and it is presented in rectangle in the figure, where it is composed of 20 samples before the peak point with 10 samples after the peak point and the peak point itself. The main reason to choose this length of data is: first, the feature extracted in the selected interval is able to provide enough distinguished information for the motion identification and moreover, it ensures a reliable real time applicability. The data shown in FIGS. 7A-7E is sampled in 200 Hz and the first 30 samples of a gait cycle for classification were utilized, which means that the motion type can be decided in approximately 0.15 s after this motion happens.

Feature Extraction

Generally, features can be defined as the abstractions of raw data. The objective of feature extraction is to find the main characteristics of a data segment which can accurately represent the original data and identify valid, useful and understandable patterns. In an embodiment, the features can be divided into various categories, time domain and frequency domain are most commonly used for recognition. The feature selection is an extremely important step because a good feature space can lead to a clear and easy classification and poor feature space may be time-consuming, computationally-expensive, and cannot lead to good result. Not all of the commonly used features in activity recognition field in selected in the system, but were analyzed the collected signal and consider the foot moving physical discipline to choose the features, which is not only effective to discriminate motion types, but also has less computation complexity. In the present embodiments, the selected features for foot motion classification are described as follows.

Mean and Variance

The mean and variance value of the three axis accelerometer and gyroscope measurement are derived from the data segment to consider as the feature, according to the following equation:

$$\{ \begin{matrix}\overline{x} = \frac{{\sum }_{1}^{N} {x}_{i}}{N} \\ {σ}^{2} = {\sum }_{i = 1}^{N} {( {x}_{i} - \overline{x} )}^{2}\end{matrix} \qquad ( 8 )$$

Where xᵢ denotes the signal, N denotes the data length, x̅, σ² denote the mean and variance value of the data sequence.

Signal Magnitude Area

The signal magnitude area (SMA or sma) is a statistical measure of the magnitude of a varying quantity, and actually is the absolute values of the signal. SMA is calculated according to equation (9).

f_{SMA}=∫ₜ_{₁}^{t}^{₂}|x|dt (9)

where, x denotes the signal and (t₁, t₂) denotes the integration time period.

Position Change

Position change is an intuitive feature for the foot direction identification, because different foot moving directions cause various position change. For example, jumping features a larger change in vertical direction, and stepping right and left lead to an obvious position change in horizontal plane. The Inertial Navigation System (INS) mechanization equation is able to provide the trajectory of a moving object in three dimensions with the measured rotation and acceleration. While, due to the double integration strategy of INS mechanization and the noise of sensor, the accumulated error will be involved in the trajectory estimation and lead to a drift of position, especially when using MEMS sensor.

Hence, it is not feasible to calculate the position during the whole identification process, the position is only derived in the data segmentation, with an initial velocity (0,0,0), initial position (0,0,0), and an zero azimuth during the calculation process. The inertial sensor has the characteristic of being accurate in short term, so the position result computed in the 30 samples interval is reliable and trustworthy. The position calculation equation is described as follows:

$$\{ \begin{matrix}{a}^{n} = {C}_{b}^{n} {a}^{b} \\ v = {v}_{0} + \int {a}^{n} dt \\ p = {p}_{0} + \int v dt\end{matrix} \qquad ( 10 )$$

Where, a^{b}, an denotes the measured acceleration in body frame and, C_{b}ⁿ is the rotation matrix that projects the acceleration from body frame to the navigation frame (local-level frame) and aⁿ denotes the projected acceleration in navigation frame. v, p denote the computed velocity and position and v₀, p₀ denote the initial velocity and position

Ratio

The ratio feature is to calculate the proportion of feature in single axis and the norm of features in three axes. The aim of introducing the ratio metric is to normalize the feature of three axes to best deal with the motion performed in different strength and users. For example, for the jump motion, the position change in up direction (jump height) is more than that in horizontal plane and is dominant in the position change, though the jump height is different for various users, the proportion of jump height in position change still occupy significantly. Specifically, the position feature (the position change) derived from a heavy jump motion maybe (0.2, 0.2, 0.5), and is (0.05, 0.05, 0.2) from a slight jump motion, though the jump height amplitude varies significantly depending on different user habits, the ratio of jump height occupies over 50% of whole position change for the both groups. Hence, the ratio feature of position change in different directions is a good metric to distinguish and evaluate the motion types with different strengths. The ratio feature introduced here is calculated as equation (11)

$$\{ \begin{matrix}FeatureNorm = \sqrt{{FeatureX}^{ 2} + {FeatureY}^{ 2} + {FeatureZ}^{ 2}} \\ ratioFeatureX = \frac{FeatureX}{FeatureNorm} \\ ratioFeatureY = \frac{FeatureY}{FeatureNorm} \\ ratioFeatureZ = \frac{FeatureZ}{FeatureNorm}\end{matrix} \qquad ( 11 )$$

Where Feature X, Y, Z denote the features calculated in different axis and the ratioFeature denote the ratio. In the present embodiments, the position, mean, variance, SMA features calculated in three directions or axes are all accounted to derive the ratio feature.

Classification

The classification is a process to predict or give the motion reorganization with the extracted features. In order to achieve a good motion classification performance, three popular supervised classification approaches are employed in our research work for validation and these three classifiers are described as follows.

Decision Tree

A decision tree is a decision support tool that uses a tree-like graph or model of decisions and their possible consequences. Generally, internal node, branch, leaf nodes are included in a decision tree classifier, where, the internal node represents a test on the selected feature, branch denotes the outcome of the test, and the leaf nodes represent the class labels (different moving directions).

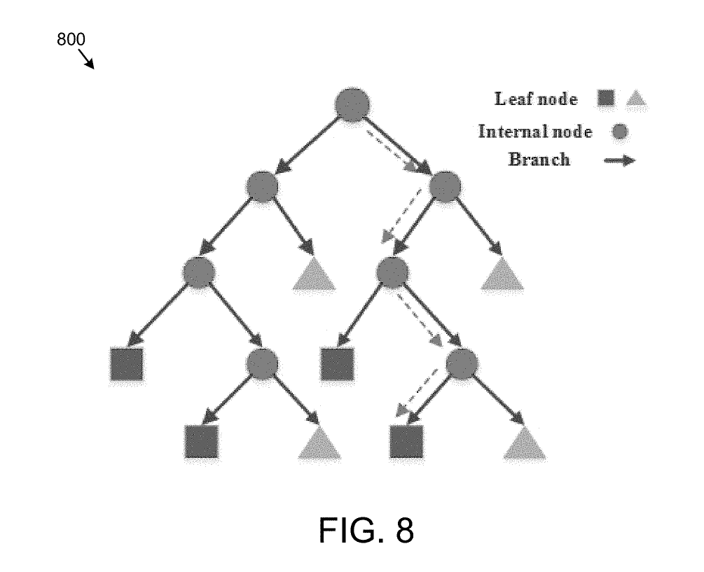

FIG. 8 illustrates a graphical model of an embodiment of a decision tree, the circle denotes the internal node that executes the test on the feature (comparison of the feature with trained parameter), the arrow denotes the test outcome and the rectangles denote the different labels or classes. The dot line from top node to the leaf node represents a decision process or classification rule.

The tree generation is the training stage of this classifier and it works in a recursive process. The general tree generation process is that, for each feature of the samples, a metric (the splitting measure) is computed from splitting on that feature. Then, the feature which generates the optimal index (highest or lowest) is selected and a decision node is created to splits the data based on that feature. The recursion procedure stops when the samples in a node belong to the same class (majority), or when there are no remaining features on which to split. Depending on different splitting measures, the decision tree can be categorized as: ID3, Quest, CART, C4.5, etc.

K-Nearest Neighbors

K-nearest neighbors algorithm (kNN) is an approach based on the closest training samples in the feature space, and k denotes the number of classes. In the kNN approach, an object is classified by a majority vote of its neighbors, with the object being assigned to the class most common amongst its nearest neighbors. Similarity measures may be components in such an algorithm and different distance measures can be used to find the distance between data points.

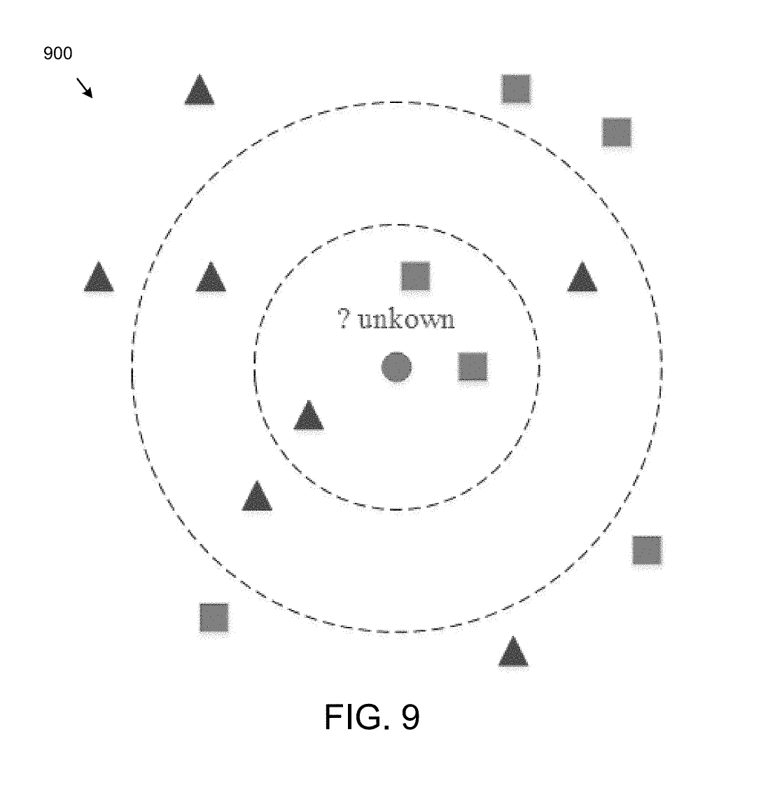

As shown in FIG. 9, the test sample (circle) is classified by the neighbors' class, either square or triangle. If k is selected as 3, the test sample is assigned to the square because two of its k neighbors belong to square. In the same way, if k=5, the test sample is assigned to green triangle class. Hence, the main idea of kNN is that the category of the predicted object is decided by the labels of the majority neighbors. Additionally, the votes of these neighbors could be weighted based on the distance to overcome the problem of non-uniform densities of the neighbor classes.

Support Vector Machine

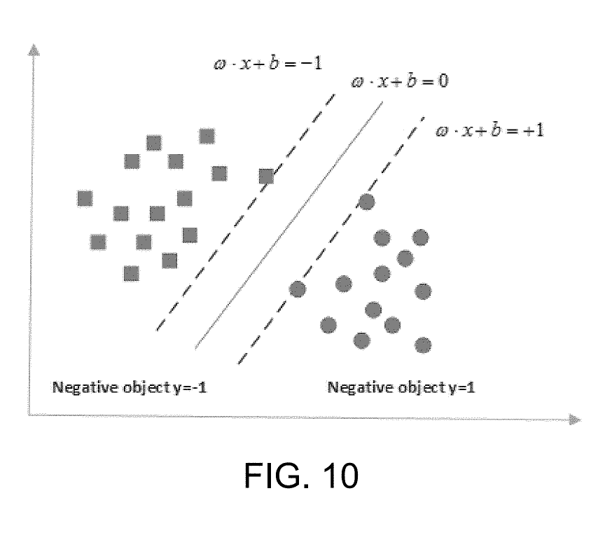

The support vector machine (SVM) is to construct a hyperplane or set of hyperplanes in a high- or infinite-dimensional space for classification, regression, or other tasks. Because several available hyperplanes are able to classify the data, and the SVM is to use the one which represents the largest separation, or margin, between the two classes to classify. The hyperplane chosen in SVM maximize the distance from it to the nearest data point on each side. FIG. 10 illustrates an embodiment of an SVM classifier.

As shown in the figure, the optimal separating hyper-plane (line) locates the samples with different label (circles 1, square −1) in the two sides of the plane, and the distances of the closest samples to the hyper-plane in each side become maximum. These samples are called support vectors and the distance is optimal margin. The specific illustration of the SVM classifier can be found in the literatures.

Experiments and Results

The experiment is designed to include two parts. In the first part, different tests are invited to perform the five foot motions in their own manners. Then we collect the data, preprocess data to remove error, divide the data into segments, extract the features and put them into the training process of introduced machine learning algorithm to derive the classifiers. Additionally, the classifiers are tested by two cross validation approaches. In the second part, the data processing procedure is transformed in our software platform and is programmed in C++, the program is also connected to the game control interface to perform the practical game playing experiment.

Date Set

In order to obtain a sufficient amount of data for training, ten testers—two females and eight males—were invited to participate in experiments. All the testers were in good health condition without any abnormality in their gait cycles. The IMU sensor was attached on their shoes, and they were asked to perform the five stepping motions in their natural manners. Moreover, in order to have diverse characteristic of each motion, some actions of the testers are conducted in different strength (heavy or slight), different frequency (fast or slow), different scope (large or small amplitude), and some actions were performed by the same tester in different days. The data collected during the experiment is stored to form the training dataset and it is reported in Table 1.

TABLE 1
Stepping motion training set

| | Jump | Left | Right | Forward | Backward |
|---|---|---|---|---|---|
| Action numbers | 895 | 954 | 901 | 510 | 515 |

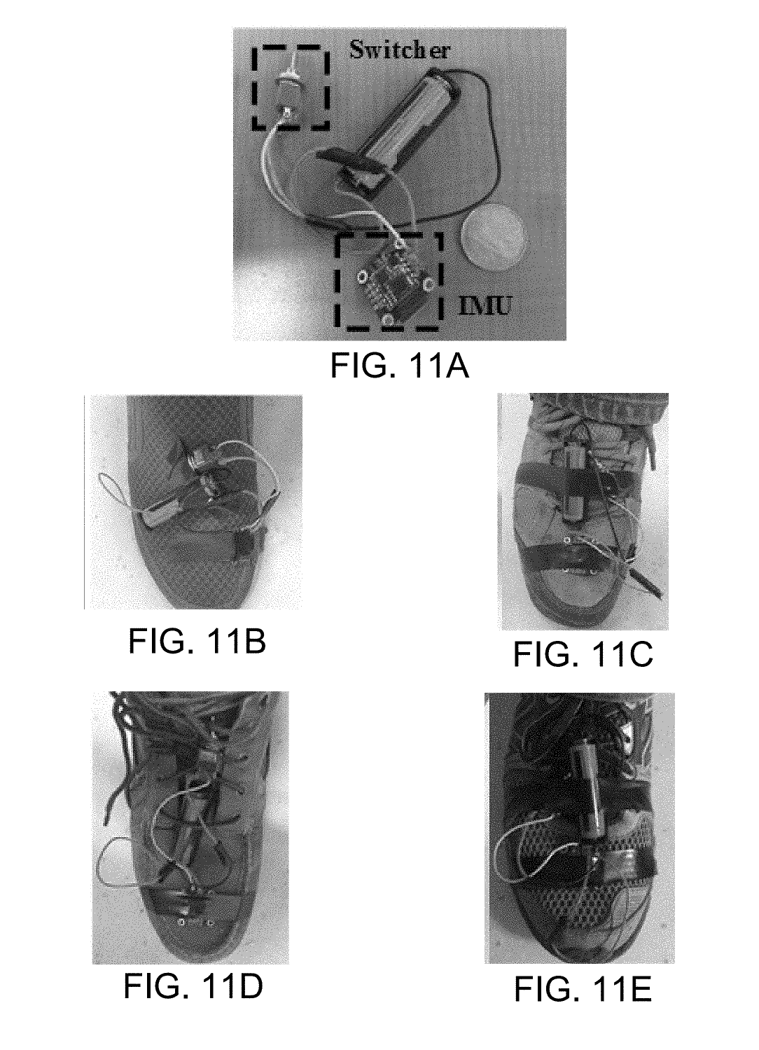

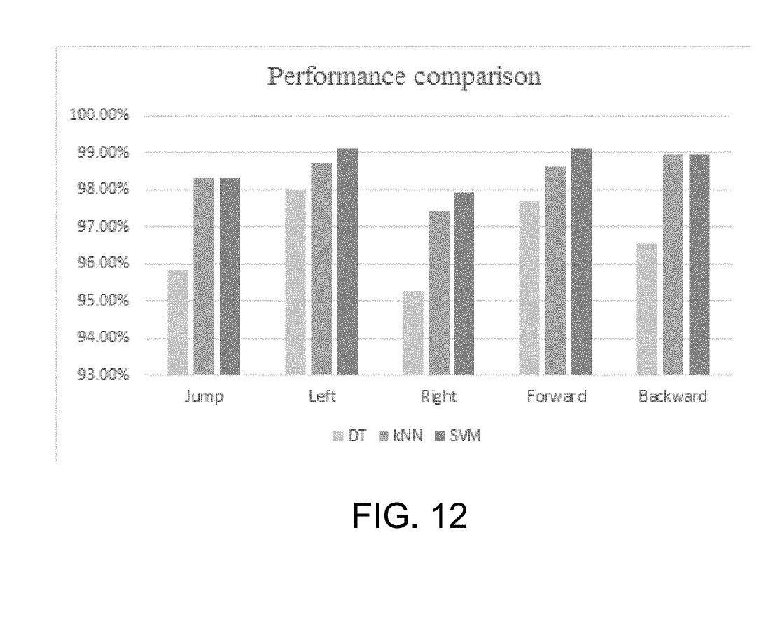

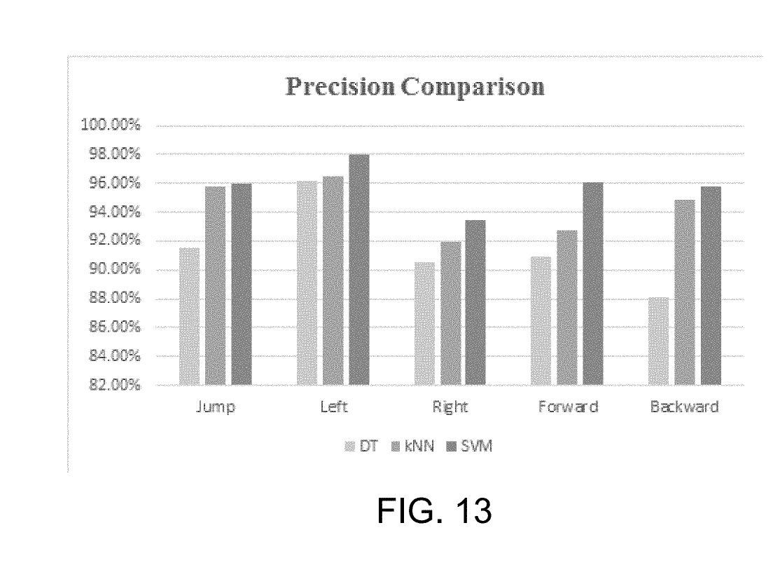

FIG. 11A shows the system hardware platform, the 3.7V lithium battery was used, which is the blue one to provide the power supply. FIGS. 11B-11E illustrate the system hardware installed on various shoe types. The IMU module has a small size, and is very convenient to mount on user's shoe. Table 1 shows the stepping motion training set, where the quantitative information of the collected human stepping motion is listed in this table. The second row lists the actual motion numbers collected in the experiment, and they include 895 jump, 954 stepping left, 901 stepping right, 510 moving forward and 515 moving backward.

Classification Result

In the present embodiments, the corresponding classifier may be trained for each motion for the motion identification instead of using one classifier for the five motions, which is beneficial to improve the robustness because one classifier only needs to recognize two classes instead of five, and it brings the possibility that the typical feature may be selected for each motion based on motion principle or data analysis in future work.

In order to have a better evaluation of the classification performance, two separate cross-validation approaches were selected for test, and they are k-fold cross validation and holdout validation. In k-fold cross-validation, the original sample is randomly partitioned into k equal sized subsamples. Of the k subsamples, a single subsample is retained as the validation data for testing the model, and the remaining k−1 subsamples are used as training data. The cross-validation process is then repeated k−1 times, with each of the k−1 subsamples used exactly once as the validation data. The k−1 results from the folds can then be averaged to produce a single estimation. The advantage of this method over repeated random sub-sampling is that all observations are used for both training and validation, and each observation is used for validation exactly once. In such an embodiment, a commonly used 10-fold test may be used. In holdout validation, a subset of observations is chosen randomly from the initial sample to form a validation or testing set, and the remaining observations are retained as the training data. Twenty-five percent of the initial samples for test and validation were chosen.

The two cross validation approaches are performed to the three classifiers and the classification results are listed in Table 2 and 3.

TABLE 2
Classification result of 10 fold cross validation

| | Decision Tree | | kNN | | SVM | |
|---|---|---|---|---|---|---|
| | Class 1 | Class 0 | Class 1 | Class 0 | Class 1 | Class 0 |
| Jump | 813/895 | 75/2880 | 870/895 | 38/2880 | 868/895 | 36/2880 |
| Left | 914/954 | 36/2821 | 939/954 | 34/2821 | 936/954 | 19/2821 |
| Right | 806/901 | 84/2874 | 881/901 | 77/2874 | 885/901 | 62/2874 |
| Forward | 470/510 | 47/3265 | 498/510 | 39/3265 | 493/510 | 20/3265 |
| Backward | 445/515 | 60/3260 | 502/515 | 27/3260 | 498/515 | 22/3260 |

TABLE 3
Classification result of 25% held out validation

| | Decision Tree | | kNN | | SVM | |
|---|---|---|---|---|---|---|
| | Class 1 | Class 0 | Class 1 | Class 0 | Class 1 | Class 0 |
| Jump | 212/223 | 15/718 | 219/223 | 8/718 | 216/223 | 8/718 |
| Left | 226/238 | 6/703 | 234/238 | 15/703 | 233/238 | 10/703 |
| Right | 198/225 | 18/716 | 219/225 | 16/716 | 217/225 | 13/716 |
| Forward | 16/127 | 9/814 | 125/127 | 13/814 | 123/127 | 7/814 |
| Backward | 114/128 | 7/813 | 126/128 | 4/813 | 126/128 | 4/813 |

Table 2 and 3 list the stepping motion identification result of the three classifiers. For each motion, the column tagged with Class 1 shows the correct detection result of actual motions and the column tagged with Class 0 denotes the undesired jump motion detected from other motions. Specifically, for the jump motion detected by decision tree classifier, 813 motions are successfully identified out of 895 jump motions (where 82 actual jump motions are miss or mistakenly detected), and 75 motions of totally 2880 other motions (the sum of left, right, forward and backward) are wrongly considered as jump motions.

Additionally, in order to have a quantification evaluation of the classifier performance, the metrics of Accuracy, Precision, Recall, are also introduced here to evaluate recognition performance. The definition and calculation equations are described below.

Accuracy: The accuracy is the most standard metric to summarize the overall classification performance for all classes and it is defined as follows:

$$Accuracy = \frac{TP + TN}{TP + TN + FP + FN} \qquad ( 12 )$$

Precision: often referred to as positive predictive value, is the ratio of correctly classified positive instances to the total number of instances classified as positive:

$$Precision = \frac{TP}{TP + FP} \qquad ( 13 )$$

Recall, also called true positive rate, is the ratio of correctly classified positive instances to the total number of positive instances:

$$Recall = \frac{TP}{TP + FN} \qquad ( 14 )$$

Where TP (True Positive) indicates the number of true positive or correctly classified results, TN (True Negatives) is the number of negative instances that were classified as negative, FP (False Positives) is the number of negative instances that were classified as positive and FN (False Negatives) is the number of positive instances that were classified as negative. According to the evaluation metrics, the accuracy, precision, recall, for the test result of each motion are calculated and listed in Table 4, 5 and 6.

TABLE 4
Evaluation of Decision tree classifier

| | 10 fold cross validation | | | 25% hold out validation | | |
|---|---|---|---|---|---|---|
| | Accuracy | Precision | Recall | Accuracy | Precision | Recall |
| Jump | 95.84% | 91.55% | 90.83% | 97.24% | 93.41% | 95.08% |
| Left | 97.98% | 96.21% | 95.80% | 98.09% | 97.41% | 94.96% |
| Right | 95.25% | 90.56% | 89.45% | 95.23% | 91.67% | 88.01% |
| For- | 97.69% | 90.90% | 92.15% | 97.35% | 92.53% | 87.45% |
| ward | | | | | | |
| Back- | 96.55% | 88.11% | 86.40% | 97.77% | 94.25% | 89.12% |
| ward | | | | | | |

TABLE 5
Evaluation of kNN classifier

| | 10 fold cross validation | | | 25% hold out validation | | |
|---|---|---|---|---|---|---|
| | Accuracy | Precision | Recall | Accuracy | Precision | Recall |
| Jump | 98.33% | 95.81% | 97.20% | 98.72% | 96.47% | 98.20% |
| Left | 98.70% | 96.50% | 98.42% | 97.98% | 93.97% | 98.31% |
| Right | 97.43% | 91.96% | 97.78% | 97.66% | 93.19% | 97.33% |
| For- | 98.64% | 92.73% | 97.64% | 98.40% | 90.57% | 98.42% |
| ward | | | | | | |
| Back- | 98.94% | 94.89% | 97.47% | 99.36% | 96.92% | 98.43% |
| ward | | | | | | |

TABLE 6
Evaluation of SVM classifier

| | 10 fold cross validation | | | 25% hold out validation | | |
|---|---|---|---|---|---|---|
| | Accuracy | Precision | Recall | Accuracy | Precision | Recall |
| Jump | 98.33% | 96.01% | 96.98% | 98.40% | 96.42% | 96.86% |
| Left | 99.09% | 98.01% | 98.11% | 98.40% | 95.88% | 97.89% |
| Right | 97.93% | 93.45% | 98.22% | 97.76% | 94.34% | 96.44% |
| For- | 99.09% | 96.10% | 96.66% | 98.83% | 94.61% | 96.85% |
| ward | | | | | | |
| Back- | 98.96% | 95.76% | 96.69% | 99.36% | 96.92% | 98.43% |
| ward | | | | | | |

Based on the evaluation metrics listed in Table 4, 5, and 6, and according to the graphically comparison of accuracy and precision, the SVM classifier has an overall better performance than the other approaches. Moreover, the average time for each classifier to make the decision on the motion type is: decision 0.0056 ms, kNN, 0.53 ms, SVM 0.0632 ms. Though the decision tree classifier has the least response time for identification, its performance on the motion type is not satisfied. The response time for SVM is 0.06 ms and it is in an acceptable time frame because this level lag will not cause an observable delay on user experience. Hence, combined with the performance and the decision time of each classifier, the SVM classifier achieve the best result and is selected in the present embodiments to classify the stepping motions.

Practical Game Play Test

The present embodiments were tested with a commercially available game application on a commercially available processing platform. In this game, an avatar is running on a railway with numerous obstacles and the traditional play manner is that the user needs to control the avatar to jump, go left, go right or get down to avoid the obstacles. In such an embodiment, foot movement direction may be used to control the avatar and the result is shown in following figures.

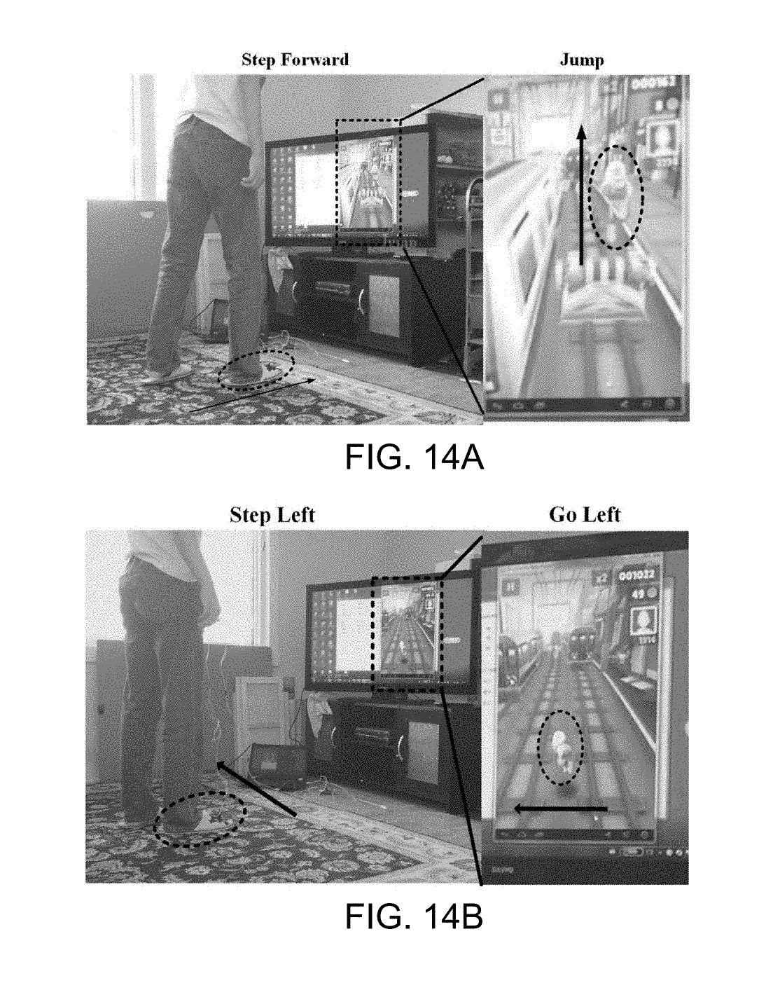

FIGS. 14A and 14B show the practical game test result. FIG. 14A illustrates that a person walking forward correlates to the jump of avatar in game operation. In the left side of this figure, the person steps forward and the arrow presents the stepping direction. The right side shows the enlarged game picture, it can be seen that the avatar selected in the circle jumps up to avoid the front obstacle. In the same way, FIG. 14B shows the person stepping left and it correlates to the avatar moving to left.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A system, comprising:
An application processing device configured to execute operational commands of an application, the application processing device comprising an input interface; and
a wearable motion detection device coupled to the application processing device via the input interface, the wearable motion detection device comprising:
a MicroElectroMechancial System (MEMS) inertial sensor configured to generate a signal characteristic of movement of the MEMS inertial sensor;
a processing device configured to process signals received from the MEMS inertial sensor to generate command inputs for the application processing device; and
an output interface, coupled to the processing device and in communication with the input interface of the application processing device, the output interface configured to communicate the command inputs to the application processing device for control of the application.

2. The system of claim 1, wherein the microcontroller is further configured to extract data from features of the signal received from the MEMS inertial sensor.

3. The system of claim 2, wherein the microcontroller is further configured to process multiple threads of instructions responsive to the data.

4. The system of claim 3, wherein the microcontroller is further configured to process a first thread for receiving and decoding data from the MEMS inertial sensor.

5. The system of claim 3, wherein the microcontroller is further configured to process a second thread for logging received data.

6. The system of claim 3, wherein the microcontroller is further configured to process a third thread for detecting a user's step in response to the signal.

7. The system of claim 6, wherein detecting the user's step comprises:
identifying a peak in the signals received from the MEMS internal sensor;
analyzing the peak to determine a phase of a gait cycle corresponding to the peak,
wherein the phase of the gait cycle is selected from a group consisting of push-off, swing, heel strike, and stance.

8. The system of claim 3, wherein the microcontroller is further configured to process a fourth thread for determining a direction for the user's step in response to the signal.

9. The system of claim 8, wherein the direction is selected from a group of directions consisting of forward, backward, left, right, up, and down.

10. The system of claim 3, where the microcontroller is further configured to process a fifth thread for interfacing with the application processing device.

11. A method comprising:
receiving a signal characteristic of movement of a MEMS inertial sensor configured to generate data in response to movement of a human foot;
processing the signal received from the MEMS inertial sensor, in a processing device, to generate a command input for an application processing device; and
communicating the command input to the application processing device for control of an application hosted on the application processing device.

12. The method of claim 11, further comprising preprocessing signals received from the MEMS inertial sensor.

13. The method of claim 12, wherein preprocessing comprises performing an alignment process using a rotation matrix for calibrating the MEMS inertial sensor.

14. The method of claim 11, further comprising segmenting the data received from the MEMS inertial sensor to divide a continuous stream of collected sensor data into multiple subsequences, each subsequence corresponding to a gait cycle.

15. The method of claim 14, further comprising:
identifying a peak in the signals received from the MEMS internal sensor;
analyzing the peak to determine a phase of the gait cycle corresponding to the peak,
wherein the phase of the gait cycle is selected from a group consisting of push-off, swing, heel strike, and stance.

16. The method of claim 14, further comprising analyzing a characteristic of the signal in the subsequence to determine a step direction corresponding to the subsequence.

17. The method of claim 11, further comprising analyzing the signal received from the MEMS inertial sensor to extract a feature of the signal corresponding to a feature of the motion of the MEMS inertial sensor.

18. The method of claim 17, wherein the feature extracted is selected from a group of features consisting of mean and variance, signal magnitude area, position change, and direction ratio.

19. The method of claim 17, further comprising classifying the signal received from the MEMS inertial sensor in response to the extracted feature.

20. The method of claim 19, wherein classifying the signal comprises selecting one of a predefined group of classifications according to a decision tree selection model.

21. The method of claim 19, wherein classifying the signal comprises selecting one of a predefined group of classifications according to a nearest neighbor selection model.

22. The method of claim 19, wherein classifying the signal comprises selecting one of a predefined group of classifications according to a support vector machine selection model.

23. The method of claim 22, further comprising generating the command input in response to the classification of the signal received from the MEMS inertial sensor.
